(19) United States
(12) Patent Application Publication
(10) Pub. No.: US 2007/0204591 A1
(43) Pub. Date: Sep. 6, 2007

(54) Grain Head Finger

(76) Inventor: Kenneth Lee Reitzel, Edon, OH (US)

Correspondence Address: Benjamin Arthur Randall, 448 W. Woodruff, Toledo, OH, 43624, US

(21) Appl. No.: 11/308,024

(22) Filed: Mar. 3, 2006

(51) Int. Cl. A01D 80/00

(52) U.S. Cl. 56/400

(57) ABSTRACT

A triangular shaped finger for use on a combine grain auger to engage the crop and promote flow through the auger. The finger is easily fitted to existing augers. The finger is constructed from a plastic-type material so it will not damage the combine if it is broken off and enters the combine machinery. The finger is shaped so that it will not capture stems and stalks during use.

The present invention relates to devices used for ensuring the smooth flow of grain through the grain head and augers of a grain harvesting machine. A typical combine grain head will include a central auger with opposing spiral flights that feeds the crop to the middle of the auger. From the middle of the auger, the crop is fed into the combine where the grain is separated from the leaves and stalks of the crop. It is common for the crop to flow in an irregular fashion along the auger forming tightly packed areas. The crop surges through the auger in what it known as “slug feed.” The slugs can become so tightly packed that the auger can be brought to a halt. The grain can also be damaged by being mechanically crushed.

It is known in the art to provide retractable fingers in the middle section of the auger to assist in breaking up the grain slugs and to promote smooth grain flow into the combine. However, these devices are mechanically complex, expensive and generally cannot be installed on existing machines without completely replacing the augers. Also, these devices are not well suited for use anywhere but in the middle section of the auger where the crop is fed into the combine. There exists a need for a device to assist the auger in moving the crop in a regular and smooth fashion along the outer portions of the auger. There also exists a need to provide a device that can be easily retrofitted to existing augers. The present invention is a device that meets both these needs. Specifically, the present invention is a stationary finger that protrudes from the center cylindrical section of an auger on a combine grain head. The finger provides mechanical agitation of the crop flow in the auger, breaking up the “slugs” and promoting crop flow. The finger is lightweight, inexpensive and easily installed on any auger.

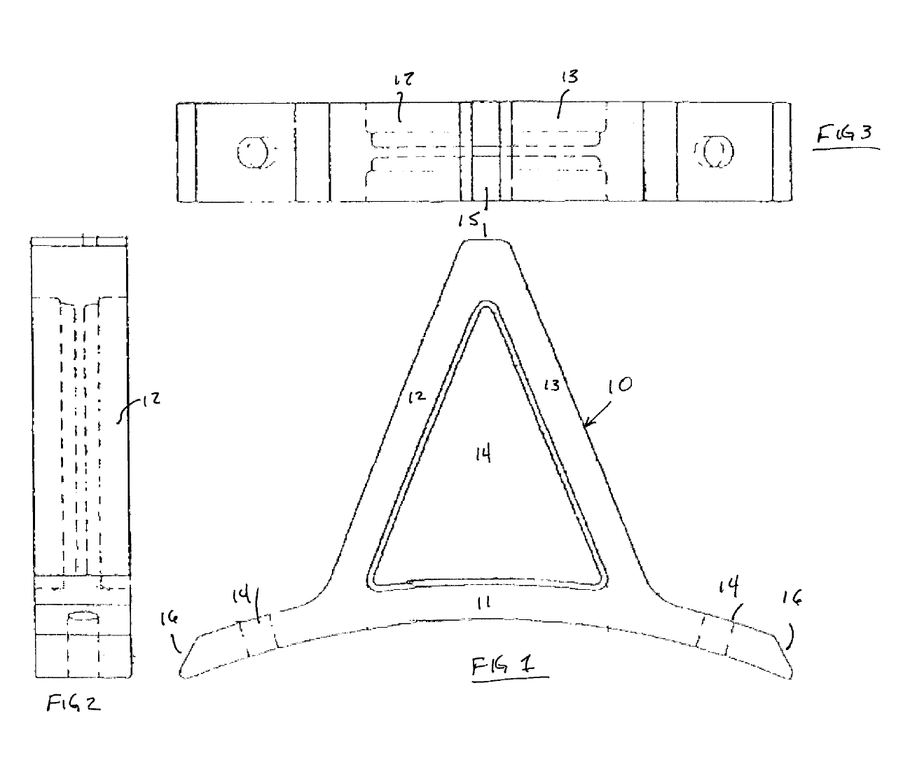

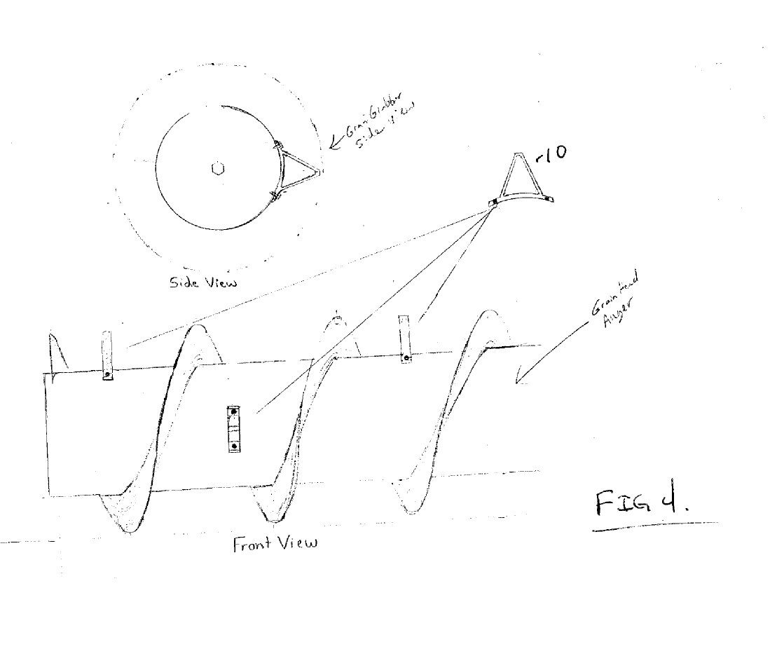

With reference to FIG. 1 and FIG. 4, the finger is seen generally at 10. The finger 10 comprises a base 11, a first oblique leg 12 and a second oblique leg 13. The legs 12 and 13 extend away from the base 11 in the same direction. The base 11 and legs 12 and 13 form a solid triangular structure with a solid center portion 14 therebetween. Referring to FIG. 2, the finger 10 can be seen edge-on and the center portion 14 can be seen as a solid web extending to the inside edge of the legs 12 and 13, and the base 11. The finger 10 in this embodiment is symmetrical around a center line. In a preferred embodiment, the center portion 14 is indented as shown to reduce the weight of the finger while achieving the required strength. Indention the center portion 14 also saves on material and reduces the cost of production.

Referring again to FIG. 1, it can be seen that the finger 10 is supplied with at least two bolt holes, 14 extending through the base 11. The bolt holes 14 allow the finger 10 to be bolted to a tubular center portion of an auger. Generally, augers are constructed so they have a hollow tubular center portion and outwardly extending spiral flighting. The finger 10 is bolted to the central tubular portion using mechanical fasteners such as bolts or screws. The base 11 is curved so when the finger 10 is mounted to the center portion of an auger, it fits tightly along the base.

When grain is harvested, the whole of the plant is introduced into the grain head, including the stalks and stems of the plant and its leaves. The finger 10 is shaped so that the stalks and stems will not become captured and travel around the auger with the finger 10. In the preferred embodiment the finger 10 is triangular with a truncated top 15. All the corners of the finger 10 are rounded to prevent the stalks and stems from becoming stuck on the finger 10. The truncated top 15 also has rounded corners for the same purpose. The base 11 has a leading edge 16 that is tapered and rounded off, also to prevent capture of stalks and stems. In the preferred embodiment a radius of one-half inch is formed at the juncture of the legs 12 and 13 and the base 11. The corners of the truncated top 15 are provided with a radius of one-quarter inch diameter. Additionally the leading edges 16 of the base 11 are provided with a one-quarter inch diameter radius at the extreme outer edge and are raked back, bottom to top for approximately three-eights of an inch. These dimension have been found to work well, but can be varied somewhat without affecting the functionality of the invention.

The preferred embodiment of the finger 10 is a truncated triangular shape with rounded corners. The width of the finger 10 is approximately one inch, the length of the base approximately 6 inches, the base of the center triangular section is approximately 3 inches, and it's height is such that is slightly less than the spiral fluting of the auger. For most augers, this is about 4 inches. Combine grain heads have a shearing knife that cuts the grain stalks. The shearing knife rides just beyond the auger flighting. If the finger 10 were to extended beyond the fluting, it could come into contact with the shearing knife and be damaged. It has been found that the triangular shape provides sufficient strength and rigidity to the finger 10 so that it performs its intended function without breaking and without causing damage to the grain. Other shapes such as polygons or hemispheres are contemplated by this disclosure.

The finger 10 is made of a plastic material such as polypropylene. This material is soft enough so that if the finger 10 or a portion of it were to break off and enter the combine, it would cause minimal damage to the other parts of the combine. In effect, the broken off part would be ground up without causing damage. A harder material such as steel could cause significant damage. Other materials that meet this requirement can be used such as other types of plastics, polyesters, fiberglass, polyurethanes, or extremely soft metal alloys.

What is claimed is:

1. A finger for attachment to the center cylindrical section of a grain auger comprising:
a base for transverse mounting to the outside of the center cylindrical section of the grain auger, comprising means for securing said base to said center cylindrical section,
a centrally located outwardly extending section having a proximal end integral with said base and a distal end to engage crop material.

2. The device of claim 1 wherein said base is a narrow member with a length greater than its width and a certain thickness, said base having a curved bottom face matching the curve of the outside of said center cylindrical section of said auger, and a top face running parallel to said bottom face,
said base further comprising two outer ends spaced away from each other and from said proximal end of said outwardly extending section, each of said ends comprising said means for securing said base to said cylindrical section.

3. The device of claim 2 wherein said outwardly extending section is triangular in shape having a first leg and a second leg extending obliquely outwards from said top surface of said base and towards each other, said first and second legs meeting at a proscribed distance from said base.

4. The device of claim 3 wherein said base, first leg and second leg form a triangular section wherein said distal end is truncated.

5. The device of claim 4 wherein said outer ends of said base have inwardly sloping surfaces such that the bottom face is extended further than the top face.

6. The device of claim 5 wherein at the point where said first and second legs extend from said top surface a radius is thereat formed.

7. The device of claim 6 wherein where said distal end and said legs meet, radii are thereat formed.
